(19) United States
(12) Patent Application Publication
(10) Pub. No.: US 2025/0355731 A1
(43) Pub. Date: Nov. 20, 2025

(54) SYSTEMS AND METHODS FOR ADVANCED COPY AND PASTE

(71) Applicant: Microsoft Technology Licensing, LLC, Redmond, WA (US)

(72) Inventors: Craig Alexander LOEWEN, Jersey City, NJ (US); Clinton Edward RUTKAS, Sammamish, WA (US); Nikola METULEV, Bothell, WA (US); Niels LAUTE, Venlo (NL)

(73) Assignee: Microsoft Technology Licensing, LLC, Redmond, WA (US)

(21) Appl. No.: 18/664,005

(22) Filed: May 14, 2024

(51) Int. Cl. G06F 9/54; G06F 3/0482; G06F 3/0484; G06F 9/451; G06F 40/166; G06F 40/58

(52) U.S. Cl. CPC G06F 9/543; G06F 3/0482; G06F 3/0484; G06F 9/451; G06F 40/166; G06F 40/58

(57) ABSTRACT

Systems and methods for advanced copy-and-paste functionality are described. After copying an item to temporary storage (e.g., a clipboard), a user may invoke an advanced paste user interface (UI) that includes a list of relevant predefined conversion functions that can be executed on the copy of the item to generate a converted item (e.g., functions that are configured to receive the data type of the item as input and produce a converted item). Such conversion functions may include functions that perform conversions between different markup languages, for example. The advanced paste UI also includes a text input field into which a user can enter a custom conversion request, which is sent, along with the copy of the item, to a large language model (LLM). The converted item is then obtained from the LLM's response.

### BACKGROUND

Many applications provide copy-and-paste functionality that enables the user to copy an item from one location in an application user interface and paste it into another location (such into another application user interface). Typically, the paste function pastes the data either as-is (e.g., the pasted data is identical to the copied data) or with minor changes to text properties, such as changing the font. It is with respect to this general technical environment that aspects of the present disclosure are directed.

### SUMMARY

Examples described in this disclosure relate to systems and methods for providing advanced copy-and-paste functionality. For example, an application and/or operating system having copy-and-paste features may include an advanced paste user interface (UI) that enables a user to convert a copied item from one format to another. The advanced paste UI displays options for a set of one or more relevant predefined conversion functions based on the type of data that has been copied. The relevant predefined conversion functions may be previously implemented functions that are configured to take the data type of the copied item as input and produce a converted item as output. When selected, each of the predefined conversion functions converts the copied data to another format and/or extracts relevant features from the copied data. For example, if the copied data is determined to be an image file, the displayed options for conversion functions may include “paste without background” and/or “paste text portion only.” If the copied data is determined to be text written in HyperText Markup Language (HTML), the displayed options may include “paste as JSON” (JavaScript Object Notation) (e.g., convert to another markup language for pasting).

In addition, the advanced paste UI includes a text input field that enables the user to directly specify the type of conversion desired. For example, if the copied text is a Java program, the user may type in the text input field “convert to Python and highlight syntax like VS” (or any other conversion request). This text may be provided as input to a language model, such as a large language model (LLM) and/or generative artificial intelligence (AI) model. The language model processes the input and generates a response. The response is then used to obtain the converted item to be pasted by identifying one or more of the relevant predefined conversion functions and/or making a subsequent call to the language model.

For instance, in some examples, the language model is given the text input and multiple predefined conversion functions and instructed to select the appropriate predefined conversion function(s) for achieving the user's request. The language model outputs a list (e.g., a set) of one or more predefined conversion function(s) and, in some examples, an order in which the predefined conversion functions should be executed on the copied item to generate a converted item to be pasted. The identified conversion functions are then executed (e.g., by local processing hardware) to convert the copied item to the converted item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 depicts a block diagram of a system for providing advanced copy-and-paste functionality according to an example.

FIG. 2 depicts components for providing advanced copy-and-paste functionality according to an example.

FIG. 3 depicts example interfaces for providing advanced copy-and-paste functionality on a computing device.

FIG. 4 depicts example interfaces for providing advanced copy-and-paste functionality on a computing device.

FIG. 5 depicts components for providing advanced copy-and-paste functionality according to an example.

FIG. 6 depicts example interfaces for providing advanced copy-and-paste functionality on a computing device.

FIG. 7 depicts example interfaces for providing advanced copy-and-paste functionality on a computing device.

FIG. 8 depicts example interfaces for providing advanced copy-and-paste functionality on a computing device.

FIG. 9 depicts components for providing advanced copy-and-paste functionality according to an example.

FIGS. 10A-10B depict example methods for providing advanced copy-and-paste functionality.

FIGS. 11A-11D depict example methods for providing advanced copy-and-paste functionality.

FIG. 12 is a block diagram illustrating example physical components of a computing device with which aspects of the disclosure may be practiced.

### DETAILED DESCRIPTION

As discussed briefly above, a system may provide an advanced copy-paste functionality that enables a user to convert a copied item into a different format for pasting, including performing advanced conversion functions to convert the copied item to a different type of data or data presentation. When the user selects an electronic item for copying (and/or deleting) and pasting, the item is stored in temporary storage of the system. The system analyzes the copied item to identify a data type of the copied item based on an analysis of the properties of the item itself and/or based on a file extension associated with the item (e.g., .html, .img, .txt, .doc, .mp4). The system filters the available predefined conversion functions to identify a set of one or more relevant predefined conversion functions based on the data type of the copied item. For example, the system may identify predefined conversion functions that are configured take the data type of the copied item as input. In some examples, the copied item and a set of predefined conversion functions are provided as input to a language model, and the language model selects the relevant predefined conversion functions.

In response to the user invoking an advanced paste UI after copying the item, the system displays a list of the selected predefined conversion functions. In some examples, the system also displays a text input field into which the user can enter text (e.g., either via keystrokes or verbally, using a microphone) requesting a custom conversion function. The user can then select a predefined conversion function from the list (e.g., to execute the conversion function on the copied item) or (if the text input field is displayed) provide a text input specifying a custom conversion function that the user wishes to have performed. In the former case, the system executes the selected predefined conversion function on the copied data and saves the converted item to the temporary storage. In the latter case, the copied item and text input may be provided via a prompt to a language model, which interprets the prompt and identifies a set of conversion functions to be performed or converts the copied item to the requested format (e.g., the format requested in the text input field). The language model outputs a response to the system that can be used to obtain the converted item (e.g., by extracting the converted item from the response and/or the performing the identified conversion functions). The converted item is saved to the temporary storage. In either case, the user can subsequently paste the converted item (e.g., from the temporary storage) by providing a paste input.

As an example of the use of a predefined conversion function, a user can select an image for copying and choose a “paste text only” conversion function from a list displayed in the advanced paste function UI. This function is configured to generate a converted item by identifying text within an image and outputting the text as plain text. The user can then paste the converted item by providing a paste input (e.g., CTRL-V). As another example, a user can select and copy a block of HTML code (e.g., text written in HTML) and choose the predefined function “paste as JSON” to convert the HTML text to JSON code. The converted item (e.g., the JSON code) is stored in the temporary storage, from which the user can subsequently paste the converted item using a paste input. Thus, the advanced paste function UI can be used to convert text written in one computer language (e.g., such as a markup language or other programming language) to text written another computer language.

For custom conversion requests, direct access to the power of a local or remote language model is implemented to perform a larger variety of custom conversion functions. For example, a natural language input from a user may be received that requests a custom conversion, such as a request that the copied text be rewritten as though a particular character had spoken it (e.g., a character having particular speech patterns, for example), or a request that text be extracted from a copied image and rewritten as though a particular character had spoken it.

In some cases, the language model may perform the custom conversion in response to the request. In other examples, the language model may be used to identify a sequence of predefined conversion functions that are executable to achieve the custom result requested by the user (e.g., rather than directly performing the conversion itself).

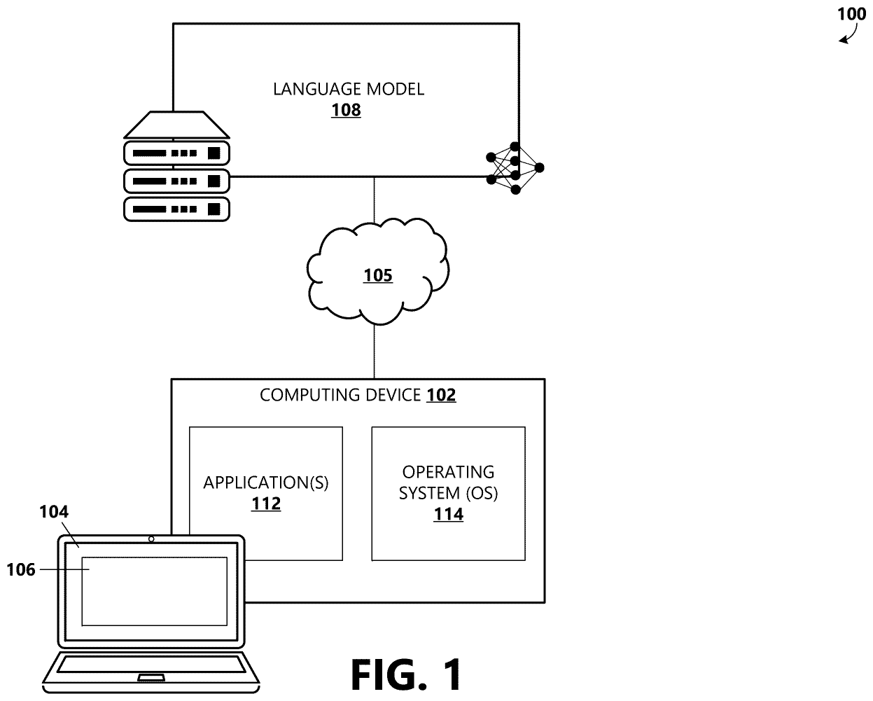

Additional details regarding systems and methods for advanced copy-and-paste functionality are described with reference to FIGS. 1-12.

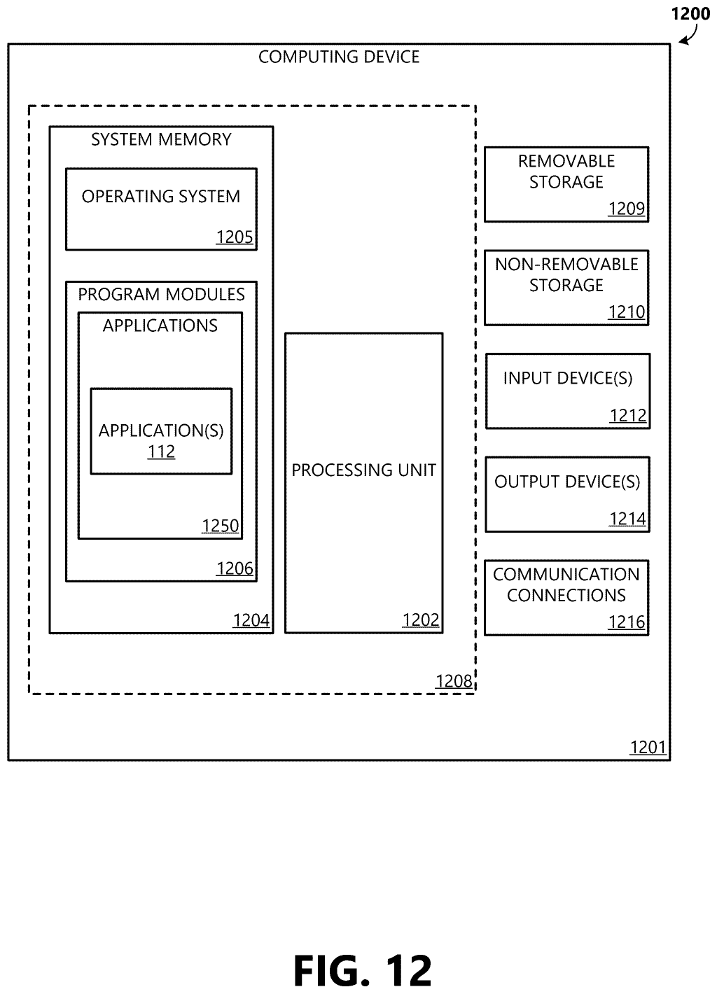

FIG. 1 is a block diagram of an example system 100 for providing advanced copy-and-paste functionality. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) (such as may be or may be included in a processing system) comprising such an operating environment is depicted in FIG. 12. In another example, the components of systems disclosed herein are distributed across multiple processing devices. For instance, an input may be entered on a user device or client device and information may be processed on or accessed from other devices in a network, such as one or more remote cloud devices or web server devices.

The example system 100 includes a computing device 102. The computing device 102 may take a variety of forms, including, for example, a desktop computer, laptop, tablet, smart phone, wearable device, gaming device/platform, virtualized reality device/platform (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 104 of the computing device 102 and can be selected and manipulated via user inputs received via a variety of input device types (e.g., keyboard, mouse, stylus, touch, spoken commands, gesture).

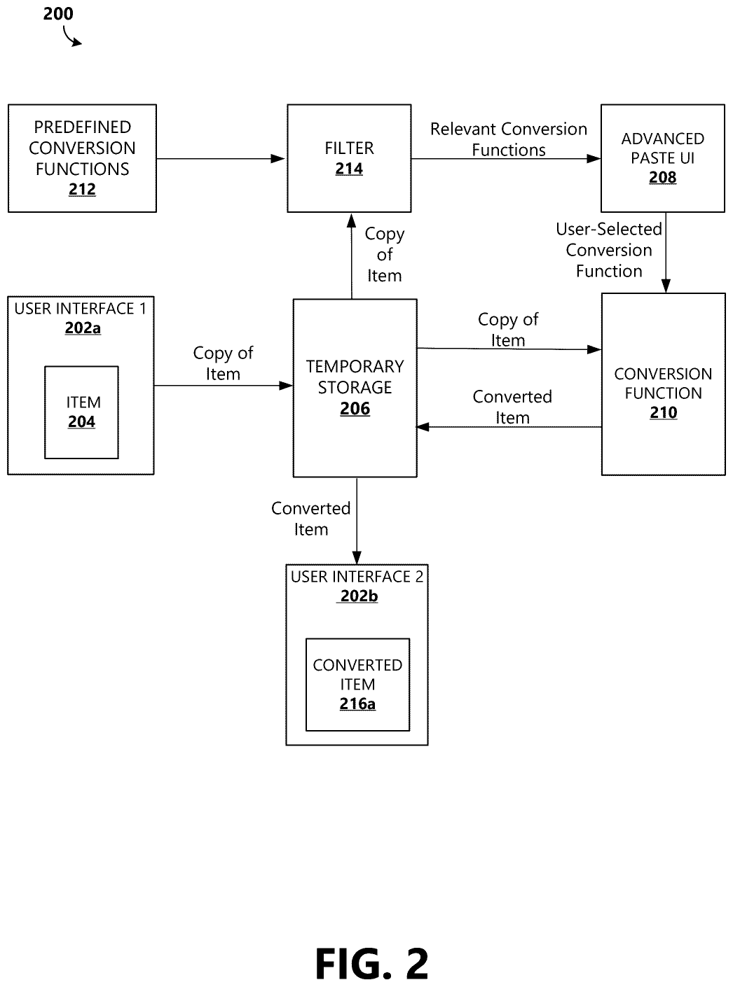

In the example of FIG. 1, display 104 displays a user interface (UI) 106 generated by an application 112 and/or by an operating system 114 operating on the computing device 102. In examples, the computing device 102 includes a plurality of applications 112 for performing different tasks, such as communicating, information generation and/or management, data manipulation, visual construction, resource coordination, calculations, etc. In some examples, the operating system (OS) 114 of the device is configured to manage applications 112, storage, and input/output devices of the computing device 102, such as described with reference to FIG. 12. The UI 106 may represent an advanced paste UI, as described in more detail with reference to FIG. 2.

The computing device 102 is in communication with a language model 108. The computing device 102 may communicate with the language model 108 via a network 105 (e.g., if the language model 108 is remote to the computing device 102) and/or via local connection(s) (e.g., if the language model 108 is executing on the computing device 102). For instance, the computing device 102 may communicate with the language model 108 using one or a combination of networks 105 (e.g., a private area network (PAN), a local area network (LAN), a wide area network (WAN)). In some examples, the language model 108 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

The language model 108 may be a generative AI model, such as a large language model (LLM), a multimodal model (i.e., which processes multiple types of inputs such as language and images), a small language model (SLM), or another type of generative AI model. Example models may include the GPT models from OpenAI, BARD from Google, and/or LLaMA from Meta, among other types of generative AI models. The language model 108 may support the custom conversion functions features discussed herein as well as identify appropriate predefined conversion functions for execution by the computing device 102. In some examples, a first language model (e.g., a cloud-based language model) supports the custom conversion functions and a second language model (e.g., a local language model) supports the identification of appropriate predefined conversion functions.

According to example implementations, the language model 108 is trained to understand and generate sequences of tokens, which may be in the form of natural language (e.g., human-like text). In various examples, the language model 108 can understand complex intent, cause and effect; perform language translation, semantic search classification, complex classification, text sentiment, summarization, summarization for an audience; and/or execute other natural language capabilities.

In some examples, the language model 108 is in the form of a deep neural network that utilizes a transformer architecture to process the text it receives as an input or query. The neural network may include an input layer, multiple hidden layers, and an output layer. The hidden layers typically include attention mechanisms that allow the language model 108 to focus on specific parts of an input, and to generate context-aware outputs. Language model 108 is generally trained using supervised learning based on large amounts of annotated text data and learns to predict the next word or the label of a given text sequence.

The size of a language model 108 may be measured by the number of parameters it has. For instance, as one example of an LLM, the GPT-4 model from OpenAI has billions of parameters. These parameters may be weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The language model 108 in examples herein, however, is pre-trained, meaning that the language model 108 has already been trained on the large amount of data. This pre-training allows the model to have a strong understanding of the structure and meaning of an input, which makes it more effective for the specific tasks discussed herein.

The language model 108 may operate as a transformer-type neural network. Such an architecture may employ an encoder-decoder structure and attention mechanisms to process the input (e.g., the text, image description and/or contextual history). Initial processing of the input data may include tokenizing the input into tokens that may then be mapped to unique integers or mathematical representations. The integers or mathematical representations are combined into vectors that may have a fixed size. These vectors may also be known as embeddings.

The initial layer of the transformer model receives the token embeddings. Each of the subsequent layers in the model may use a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: an attention (e.g., self-attention, windowed attention, or another type of attention) sub-layer and a feed-forward neural network sub-layer. The self-attention mechanism mentioned above is applied first, followed by the feed-forward neural network. The feed-forward neural network may be the same for each position and apply a simple neural network to each of the attention output vectors. The output of one layer becomes the input to the next. The output of the final layer may be processed and passed through a linear layer and a SoftMax activation function. This outputs a probability distribution over all possible tokens in the model's vocabulary. The token(s) with the highest probability is selected as the output token(s) for the corresponding input token(s).

FIG. 2 is a block diagram of example components of a system 200 for providing advanced copy-and-paste functionality. System 200 includes a first user interface 202a in which an electronic item 204 is displayed or otherwise presented. The first user interface 202a may be, for example, a browser UI, a document editing UI, or another type of UI generated by an application or by an operating system. The item 204 may be or may include, for example, an electronic file, image, bitmap, plain text, formatted text, text written in a markup language, audio clip, or another type of electronic item (e.g., an electronic item having a different data type than those listed herein). The item 204 may be or may be associated with (e.g., included in) a file having a file extension that indicates the data type of the item 204, such as .html (html code), .jpeg (e.g., image), .txt (e.g., unformatted text), .doc (e.g. formatted text), .mp3 (e.g., audio), or other file extension.

In response to detecting a user input indicating a request to copy the item 204, the system 200 stores a copy of the item in temporary storage 206 (e.g., in a clipboard). The temporary storage 206 may include RAM memory or another type of memory, for example. The user may indicate a request to copy the item 204 by inputting one or more keystrokes (or other inputs), such as by depressing CTL-C while the item 204 is selected, selecting the item 204 from a menu, providing a verbal command to copy the item 204, or via other inputs requesting to copy item 204.

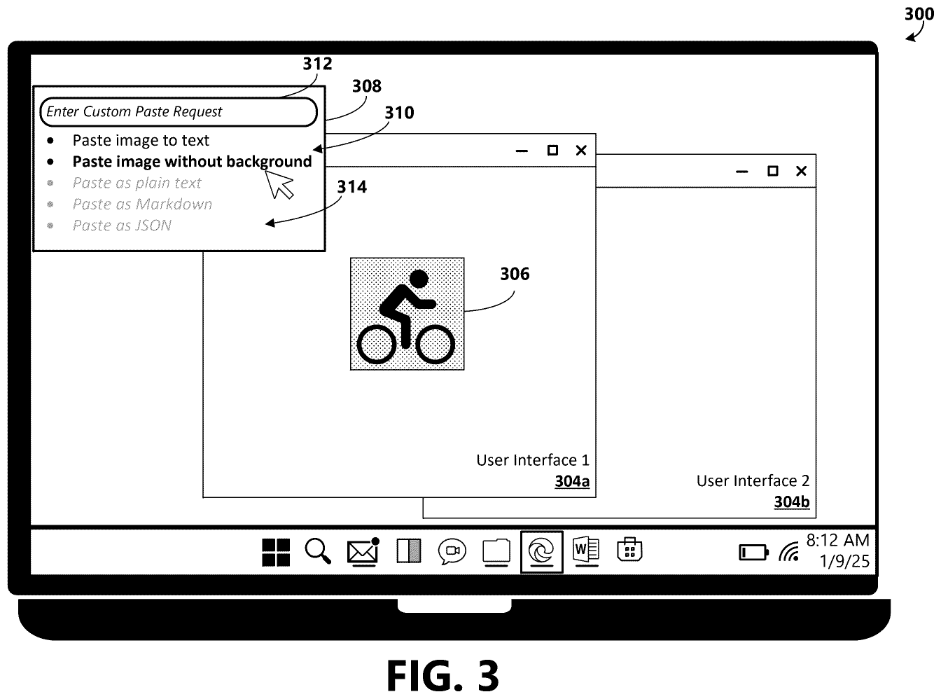

In response to detecting a subsequent user input (such as one or more keystrokes, selection from a menu, and/or a verbal command) indicating a request to invoke an advanced paste UI (e.g., after and/or while the item 204 is saved in the temporary storage 206), the system 200 displays the advanced paste UI 208. As described in more detail with reference to FIG. 3, the advanced paste UI 208 includes affordances representing a set of relevant predefined conversion functions (e.g., conversion functions that are configured to receive data having the data type of the item 204 as input and produce a converted item as output).

In some examples, in response to detecting the user input indicating a request to invoke the advanced paste UI 208, the system 200 retrieves a set of predefined conversion functions 212 (e.g., a library of predefined conversion functions). For instance, the library of the predefined conversion functions 212 may be initially populated with functions from the operating system of the computing device. In some examples, applications, plug-ins, and/or other software components may provide additional predefined conversion functions 212 to the library.

The system 200 uses a filter 214 to identify, from the set of predefined conversion functions and based on the data type of the copy of the item, the list of relevant predefined conversion functions to be displayed in the advanced paste UI 208. In some examples, the filter 214 identifies the list of relevant predefined conversion functions by identifying functions that are configured to take items having the data type of the item 204 as input and produce a converted item as output. The system displays, in advanced paste UI 208, affordances (e.g., icons or other selectable elements) representing corresponding relevant predefined conversion functions.

In response to detecting a user selection of an affordance representing one of the relevant predefined conversion functions, a conversion function module 210 executes the selected conversion function on the copy of the item and outputs a converted item 216a. The system 200 saves the converted item 216a in the temporary storage 206 for subsequent pasting by the user.

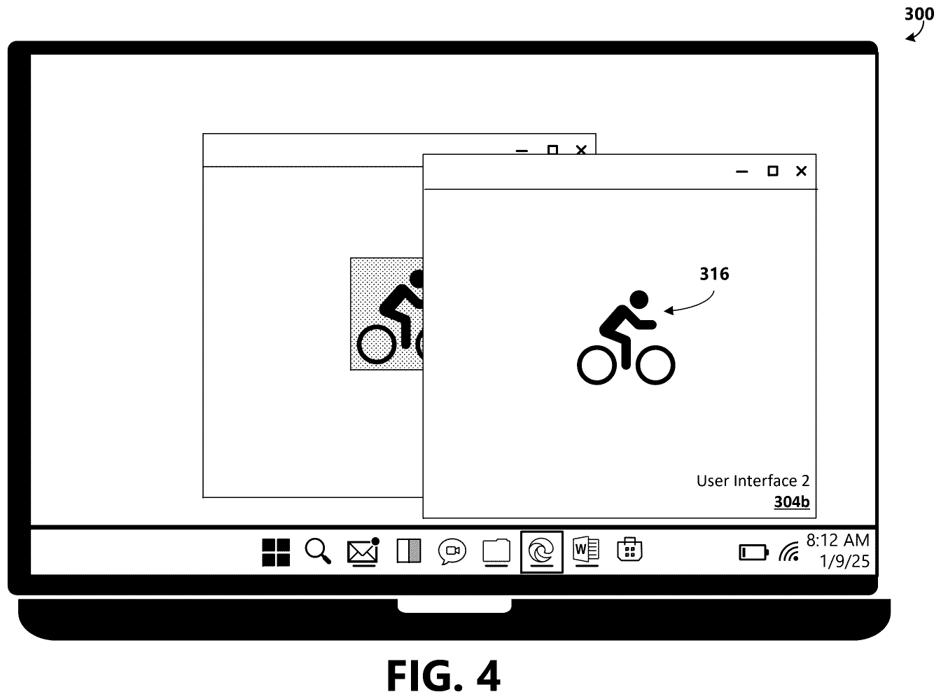

In response to detecting a user input indicating a request to paste the converted item 216a into a second user interface 202b, the system 200 pastes (e.g., places, copies, displays) the converted item 216a at a location indicated by the user. For example, the user may provide a user input indicating the request to paste the converted item 216a after the user has activated the second user interface 202b and placed the cursor at the desired paste location, and the system 200 may respond by pasting the converted item at the paste location within the second user interface 202b. An example of the approach described with reference to FIG. 2 is illustrated by FIGS. 3-4 and described below.

FIG. 3 depicts a computing device 300 displaying a first user interface 304a, a second user interface 304b, and an advanced paste UI 308. In the example of FIG. 3, the user has selected item 306 in the first user interface 304a (e.g., by clicking on item 306, drawing a bounding box around item 306, or providing another user input to select item 306). After selecting item 306, the computing device 300 has detected a user input indicating a request to copy item 306, such as by detecting the use of a hot key (e.g., a selection of a key or keys on a keyboard, such as CTL-C) or by detecting another type of user input. In response to detecting the user input indicating a request to copy item 306, the computing device 300 saves a copy of the item 306 in temporary storage, such as a clipboard. In some examples, the temporary storage is a storage that is used to store a copy of an item(s), where the copied item(s) is/are overwritten when subsequent item(s) is/are copied to the temporary storage. In some examples, the temporary storage stores a single copied item that is overwritten or deleted when another item is copied to the temporary storage. In some examples, the temporary storage is configured to store a fixed number of copied items before overwriting any of the copied items with a new copied item.

In response to detecting a subsequent user input indicating a request to display an advanced paste UI, the computing device 300 identifies a data type of the item 306 and selects one or more relevant predefined conversion functions based on the data type. The computing device 300 then displays the advanced paste UI with selectable affordances 310 that may be used, by the user, for selecting one of the one or more relevant predefined conversion functions (e.g., relevant predefined conversion functions identified by the filter 214 in FIG. 2).

In the example of FIG. 3, the item 306 is an image (e.g., the data type of the item 306 is image) so the two selectable affordances shown in the advanced paste UI 308 (“Paste image to text” and “Paste image without background”) correspond to two predefined conversion functions that are configured to take image data as input and produce a converted item. In this example, several other non-selectable affordances 314 are displayed (“Paste as plain text,” “Paste as Markdown,” “Paste as JSON”), each of which corresponds to a predefined conversion function that is not relevant to the data type of the item (e.g., is not configured to process image data, in this example). Such affordances may have been selectable if the data type of the item 306 had been different (e.g., if the data type had been formatted text or html, for example). In other examples, only selectable affordances are displayed (e.g., only affordances for relevant predefined conversion functions), and the display of affordances for predefined conversion functions that are not relevant to the data type of the item is suppressed.

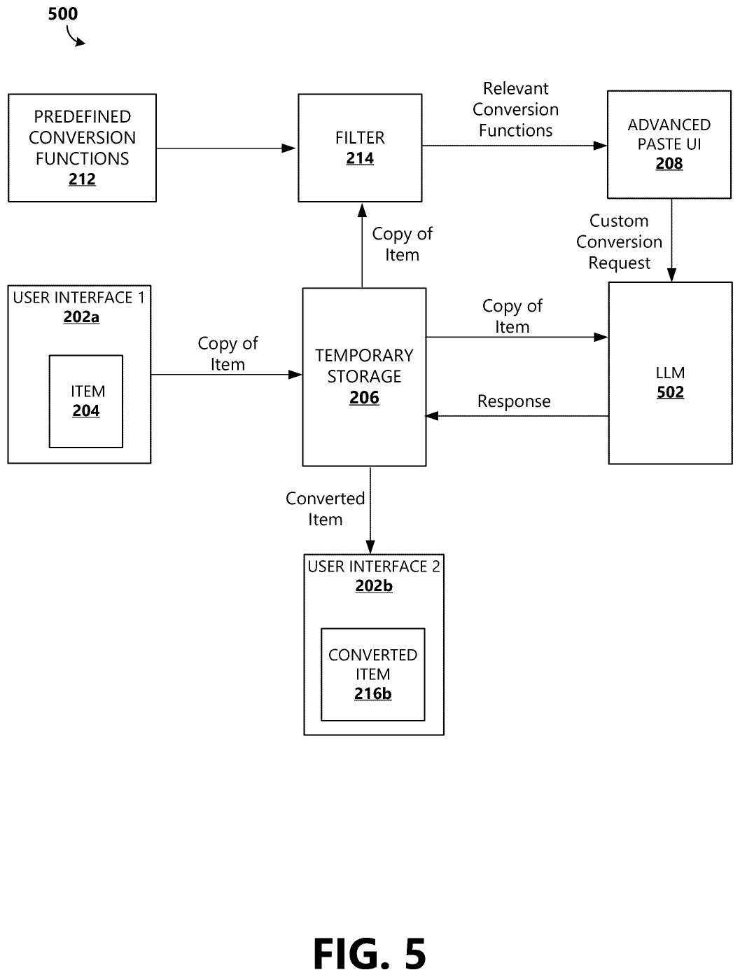

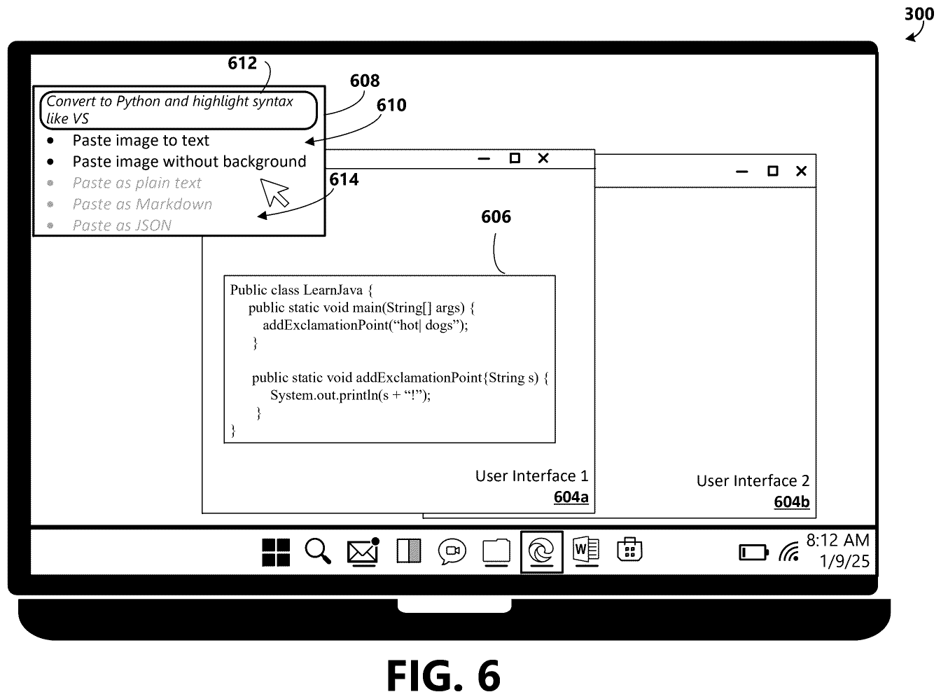

The advanced paste UI 308 also includes a text input field 312 into which the user can enter a natural language request for a custom conversion function. This capability is discussed in more detail with reference to FIGS. 5-6.

In the example of FIG. 3, the user selects the “Paste image without background” affordance, such as by clicking on the affordance or by providing a different selection input directed to the affordance. In response to detecting the user selection of this affordance, the computing device 300 executes a corresponding predefined conversion function on the copy of the item in the temporary storage and outputs a converted item. The computing device stores the converted item in the temporary storage for subsequent pasting by the user.

FIG. 4 depicts the computing device 300 after the user has pasted the converted item 316 into the second user interface 304b. For example, the user has provided a user input indicating a request to paste the converted item into the second user interface 304b, such as by clicking on a location within the second user interface 304b at which the user wishes to paste the converted item. In response to detecting the user input indicating a request to paste the converted item, the computing device pastes the converted item 316 in the second user interface 304b. As shown in FIG. 4, the converted item 316 includes a first portion of the item 306 (e.g., the cyclist and excludes a second portion of the item (e.g., the background). In some examples, in response to detecting the user input indicating a request to paste the converted item, the system 200 also ceases to display the advanced paste UI.

FIG. 5 depicts another block diagram of example components of a system 500 for providing advanced copy-and-paste functionality. System 500 includes some of the same components as system 200 of FIG. 2 and adds an LLM 502, which may be an example of the language model 108 discussed with reference to FIG. 1.

In the example of FIG. 5, instead of selecting an affordance representing a predefined conversion function, the user inputs natural language text in the text input field of the advanced paste UI 208 (e.g., text input field 312 of advanced paste UI 308 in FIG. 3). In this case, the system 500 (e.g., a computing device of the system 200) may generate a prompt for the LLM 502, where the prompt includes a copy of the item 204 and the natural language text entered into the text input field (e.g., the custom conversion request). Generation of the prompt may include accessing a prompt template that includes static text and dynamic placeholders. The static text may include instructions for what operations the LLM 502 is to perform. For example, the static text may include instructions, such as: “A requested conversion is provided below along with the copied data that is to be converted. Perform the requested conversion.” The dynamic placeholders may include placeholders for the text from the text input field (e.g., the custom conversion request), the copied data, and a determined type of the copied data, among others.

The system 500 sends the prompt to the LLM 502 (which may be local or remote) and receives a response from the LLM 502. The system 500 obtains a converted item based on the response from the LLM 502. In some cases, the response from the LLM 502 includes the converted item and the system 500 obtains the converted item by extracting it from the response. In some cases, the system 500 obtains the converted item by formatting data included in the response (e.g., formatting an image and/or text received in the response to match a destination formatting, such as font format of a destination document for the paste operation). The system 500 saves the converted item 216b in the temporary storage 206 for subsequent pasting by the user.

In the example of FIG. 5, like in FIG. 2, a user input is received requesting to paste the converted item 216b into the second user interface 202b. It should be understood, however, that the user may choose to paste the converted item into the same user interface from which the user copied the (original) item (e.g., the user may paste the converted item into the first user interface 202a).

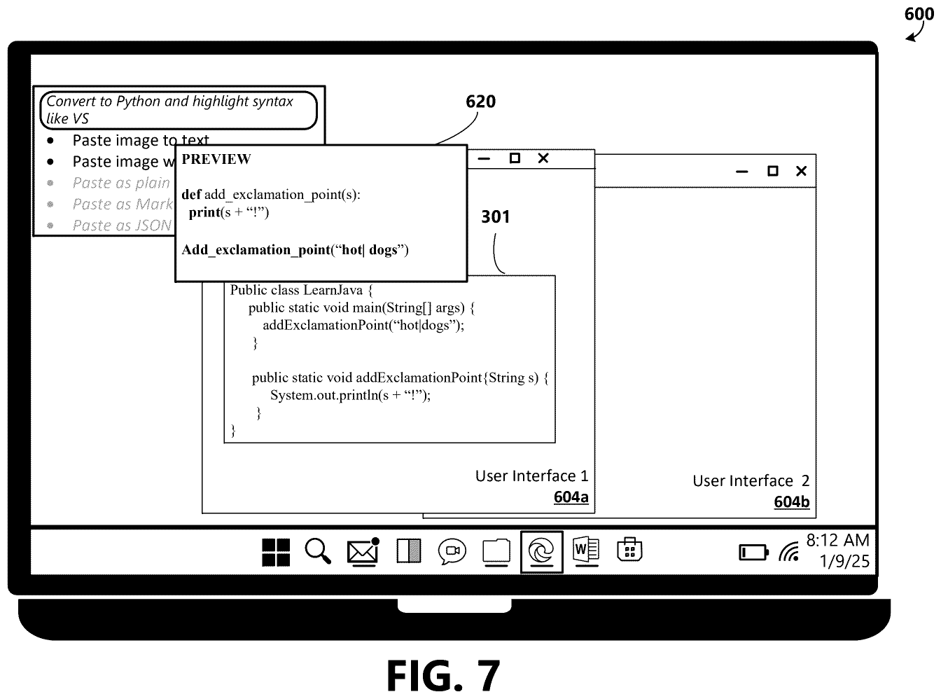

An example of the above-described approach is illustrated by FIGS. 6-7.

FIG. 6 depicts a computing device 600 displaying a first user interface 604a, a second user interface 604b, and an advanced paste UI 608. In the example of FIG. 6, the user has selected item 606 in the first user interface 604a. In this example, item 606 has an image data type, and may be a screen shot from a video programming tutorial. (In another example, the user may have selected the same text via cursor.) After selecting the item 606, the computing device 600 detects a user input indicating a request to copy item 606, and in response, the computing device 600 stores a copy of the item 606 in temporary storage.

In response to detecting a subsequent user input indicating a request to display an advanced paste UI, the computing device 600 identifies a data type of the item 606 and selects one or more relevant predefined conversion functions based on the data type (e.g., as described with reference to FIG. 2). The computing device 600 then displays the advanced paste UI 608 with selectable affordances 610 for selecting one of the one or more predefined conversion functions. Because the item 606 is an image (like in FIG. 3), the two selectable affordances shown in the advanced paste UI 608 (“Paste image to text” and “Paste image without background”) correspond to two predefined conversion functions that are configured to process image data to produce a converted item. As in FIG. 3, in this example, other non-selectable affordances 614 are displayed (“Paste as plain text,” “Paste as markdown,” “Paste as JSON”). These items are non-selectable because the predefined conversion functions are not relevant to the copied item discussed in this example, but may be selectable if the copied item were a different data type, such as if the copied item were a code snippet.

The advanced paste UI 608 also includes a text input field 612 into which the user can enter a natural language request for a custom paste conversion function (e.g., in the case when the predefined conversion functions do not provide the desired functionality). In the example of FIG. 6, the user enters the text input “Convert to Python and highlight syntax like VS.”

In response to detecting the text input, the computing device 600 generates a prompt for an LLM (e.g., LLM 502). The prompt includes the copy of the item and the text input. The computing device 600 sends the prompt to the LLM. In this case, based on the text input and the copy of the item received in the prompt, the LLM may extract the text from the image file, convert the text to the Python programming language, and highlight the syntax of the resulting Python text like (e.g., in a manner similar to) Visual Studio (VS) code (e.g., where certain keywords or commands are displayed in a different color and/or bolded, for example).

The LLM sends a response to the computing device 600, and the computing device 600 obtains the converted item based on the response. The computing device 600 stores the converted item in the temporary storage for subsequent pasting by the user.

As shown in FIG. 7, in some examples, after obtaining the converted item and before receiving a user input requesting to paste the converted item, the computing device 600 displays a preview 620 of the converted item (e.g., so that the user can determine if the converted item is as expected before pasting the converted item). For example, the computing device 600 displays, as a preview, at least a portion of the converted item in the advanced paste UI or in a different window. In some examples, the computing device 600 displays the preview 620 in response to receiving the response from the LLM and/or in response to obtaining the converted item. In some examples, the computing device 600 displays the preview concurrently with displaying the advanced paste UI 608.

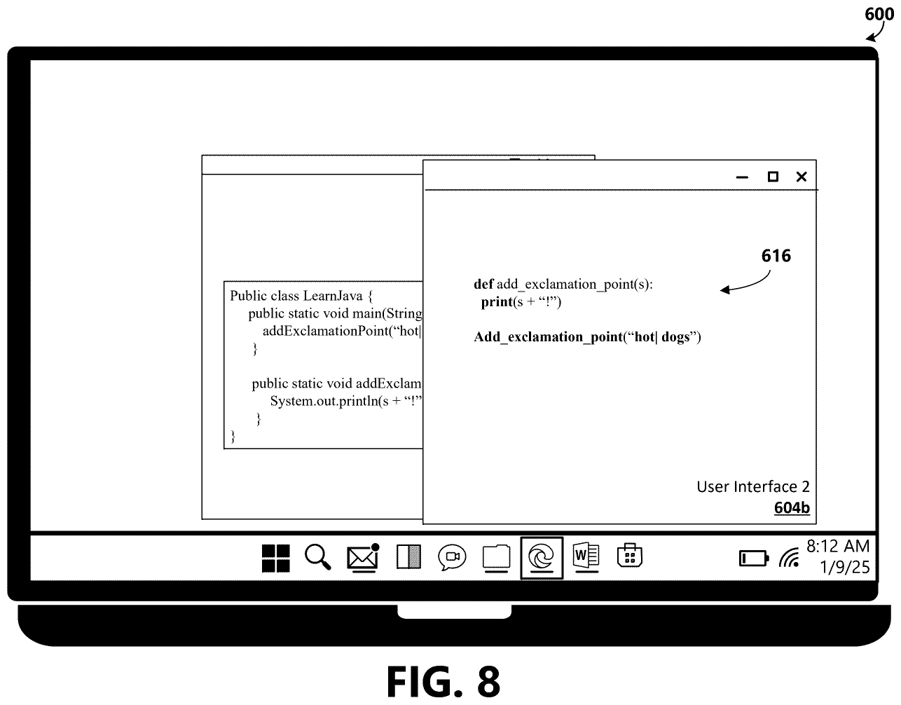

FIG. 8 depicts the computing device 600 after the user has pasted the converted item 616 into the second user interface 604b. As shown in FIG. 8, the converted item 616 includes some bolded keywords (“def,” “print,” etc.), which indicates that the LLM highlighted the Python text like VS, as requested.

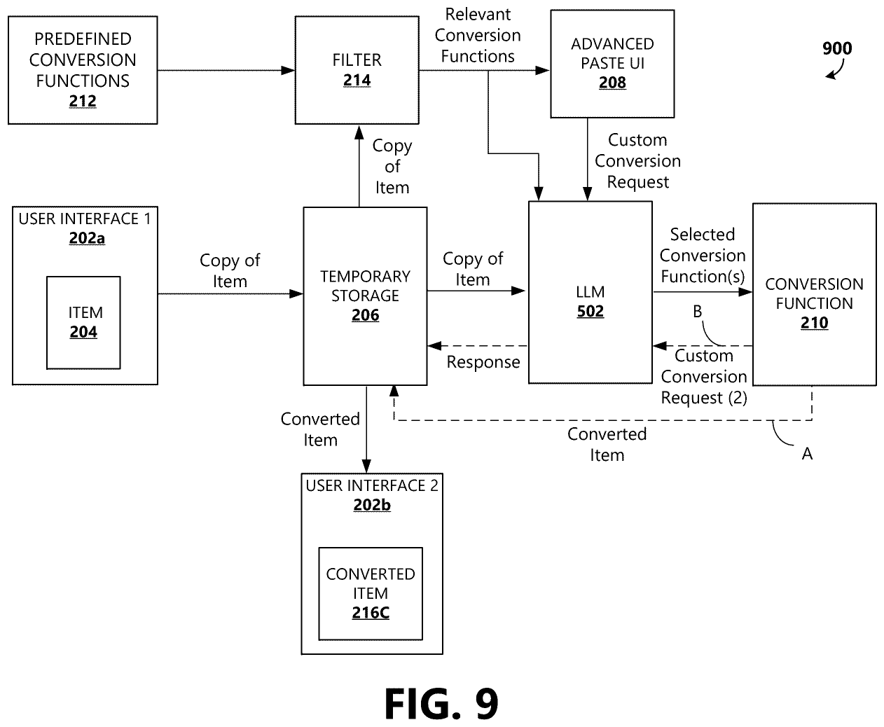

FIG. 9 depicts another block diagram of example components of a system 900 for providing advanced copy-and-paste functionality. System 900 includes some of the same components as system 200 and 500 of FIGS. 2 and 5, respectively.

In the example of FIG. 9, the system 900 uses the LLM 502 to select, based on a custom conversion request received as a text input in a text input field, one or more predefined conversion functions that can be executed sequentially or in parallel on the copy of the item to generate the converted item or, as described below, to generate an additional prompt for the LLM 502. For example, in response to detecting a text input in a text input field of an advanced paste UI (e.g., text input field 312, 612), the system 900 generates a first prompt for the LLM 502 that includes a list of some or all of the predefined conversion functions 212 (such as, for example, relevant predefined conversion functions that are identified based on the data type of the copy of the item as described with reference to FIG. 2) and the text input. The list of functions in the prompt may include the titles and/or descriptions of or references to the functions rather than including all operations and code performed by the functions. In some examples, the list of conversion functions includes all of the available predefined conversion functions or all of the available relevant predefined conversion functions.

In some examples, the system 900 performs additional operations to select a subset of the available predefined conversion functions to include in the prompt. For instance, in some examples, hundreds or thousands of predefined conversion functions (or relevant predefined conversion functions) may be available in the function library. Including all of these functions within a prompt for an LLM may not be optimal, and/or prompt-length limitations may prevent all functions from being incorporated into the prompt. Accordingly, a subset of the available functions that are semantically relevant to the input text for the custom conversion may first be identified, such as using embedding vectors as described below.

Selecting the subset of the predefined conversion functions may be performed via an embedding comparison process. For example, a first embedding is generated for the text input requesting the custom conversion. This embedding may be referred to as a requested-conversion embedding. Function embeddings may then be generated for each of the predefined conversion functions (or in some cases, for each of the relevant predefined conversion functions). These embeddings may be referred to as function embeddings. The function embeddings may be generated from the titles and/or descriptions of the functions rather than the actual mathematical operations contained within the functions. The requested-conversion embedding is then compared to the generated function embeddings to determine a semantic similarity between each function and the requested conversion. Such a comparison may be performed via a cosine similarity analysis or other types of vector-based comparisons. The predefined conversion functions corresponding to the closest function-vectors are then selected as the subset of predefined conversion functions for inclusion in the prompt. The number of the closest functions may be a predetermined number, such as 10, 20, 30, etc, functions. In other examples, the number of closest functions that are selected are those that exceed a closeness threshold (e.g., above a normalized closeness threshold from the cosine similarity analysis).

The prompt (e.g., including the copy of the item, the text input, and a set of relevant predefined conversion functions) further includes static text that instructs the LLM 502 to identify one or more relevant predefined conversion functions that can be executed to generate a converted item that will satisfy the user's requested conversion function. The system 900 provides the prompt to the LLM 502, which identifies which of the available predefined conversion functions can be used to generate a converted item based on the input text (e.g., to respond to the user's request) and the list of relevant predefined conversion functions. The LLM responds with a list of one or more selected predefined conversion function(s) and, in some examples, an order in which the selected functions should be executed (if there are more than one). The list of selected predefined conversion function(s) and (optionally) the execution order is/are provided to the conversion function module 210, which executes the selected predefined conversion function(s) in the order specified by the LLM 502 (if any). In some examples, executing the selected predefined conversion function(s) generates the converted item 216c, shown in path A of FIG. 9. The converted item 216c is stored in the temporary storage 206, and subsequently pasted into the second user interface 202b.

In some examples, the selected conversion function that is identified by the LLM 502 is a “too custom” function that, when executed by the conversion function module 210, generates a second prompt for the LLM 502 (shown in path B of FIG. 9). The too custom function is used in examples where there are no predefined conversion functions in the set of predefined conversion functions (e.g., excluding the “too custom” function) that are appropriate or capable of performing the requested conversion (e.g., the conversion request is too custom). For example, the LLM 502 may identify the “too custom” function in cases where the remaining predefined conversion functions in the set of predefined conversion functions fail to satisfy a threshold related to their capability to generate an appropriate converted item. The “too custom” function defines a set of operations for using the LLM 502 to perform the requested conversion. In such examples, execution of the “too custom” function causes a secondary prompt (e.g., a second custom conversion request) to be generated by the conversion function module 210, which provides the secondary prompt to the LLM 502. The secondary prompt includes the text input from the user requesting the conversion of the copied item and the copied item itself, similar to the custom conversion request discussed with reference to FIG. 5. The secondary prompt also includes instructions, to the LLM 502, to convert the copied item based on the text input. The LLM 502 processes the secondary prompt and generates the converted item, which is then stored in the temporary storage 206 for pasting.

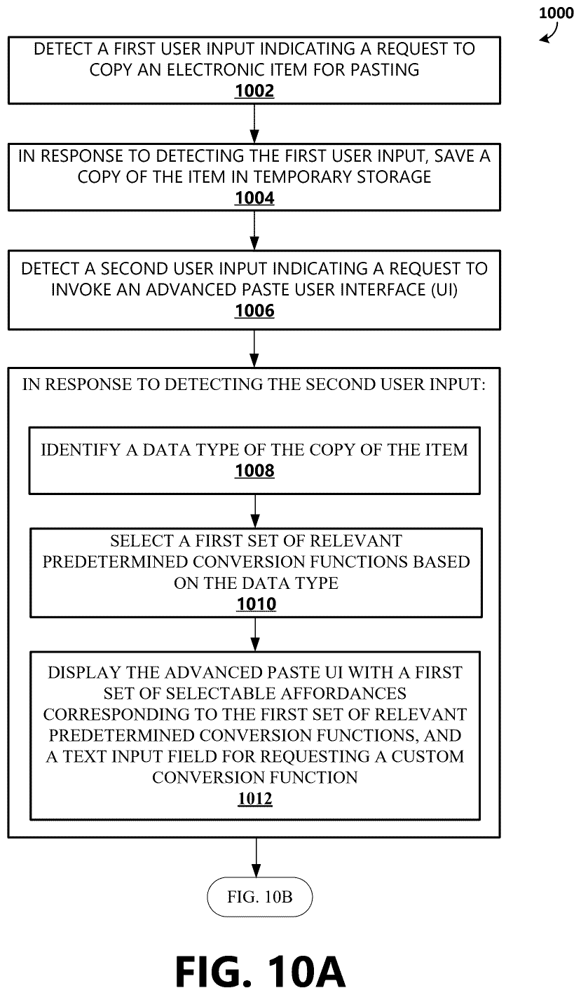

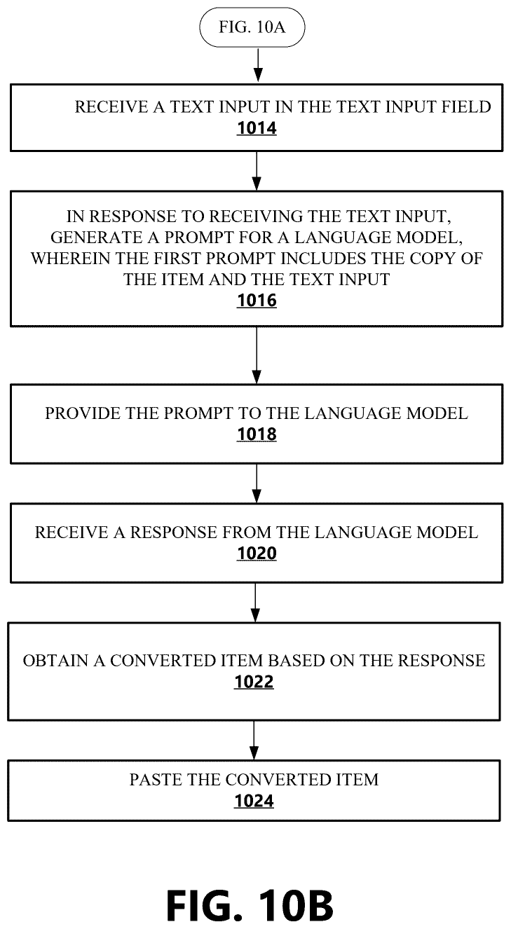

FIGS. 10A-10B depict an example method 1000 for providing advanced copy-and-paste functionality. Method 1000 may be performed by a system (e.g., system 200, 500, 900), such as by a computing device of the system (e.g., computing device 300, 600, and/or 1200).

At operation 1002, the computing device detects a first user input indicating a request to copy an electronic item (e.g., item 204) for pasting, such as described with reference to FIGS. 2-9. At operation 1004, in response to detecting the first user input, the computing device saves a copy of the item in temporary storage (e.g., temporary storage 206), such as described with reference to FIGS. 2-9.

At operation 1006, the computing device detects a second user input indicating a request to invoke an advanced paste UI (e.g., advanced paste UI 308), such as described with reference to FIGS. 2-9. In response to detecting the second user input, the computing device performs operations 1008 through 1012.

At operation 1008 the computing device identifies a data type of the copy of the item, such as by analyzing the content of the copy of the item and/or analyzing a file extension associated with the copy of the item (e.g., a file extension of a document from which the item was copied). At operation 1010, the computing device selects a first set of relevant predefined conversion functions based on the data type, as described with reference to FIGS. 2-9. The first set of relevant predefined conversion functions may include one or more relevant predefined conversion functions that are selected from a library of available predefined conversion functions based on the data type of the copy of the item (which is the same as the data type of the item).

At operation 1012, the computing device displays the advanced paste user interface with a first set of selectable affordances corresponding to the first set of relevant predefined conversion functions, and a text input field for requesting a custom conversion function, such as depicted in the advanced paste UI 308 of FIGS. 3 and 6. Each of the selectable affordances can be selected by the user to execute a corresponding relevant predefined conversion function.

At operation 1014, the computing device receives a text input in the text input field as described with reference to FIG. 6. For example, the user inputs natural language text that describes a custom conversion request that the user wishes to have the system perform on the copy of the item.

At operation 1016, in response to receiving the text input, the computing device generates a prompt for a language model (e.g., LLM 502, which may be a generative AI model), where the prompt includes the copy of the item and the text input. In some examples, the prompt instructs the language model to perform a custom conversion function on the copy of the item based on the user's custom conversion request.

At operation 1018, the computing device provides the prompt to the language model as shown in FIG. 5 (e.g., by providing the copy of the item and the custom conversion request), such as by sending the prompt to the language model via an internal and/or external network or providing the prompt to a local language model.

At operation 1020, the computing device receives a response from the language model. In some examples, the response includes a converted item (e.g., an electronic item corresponding to the copy of the item after the custom conversion request has been executed on the copy of the item). At operation 1022, the computing device obtains a converted item based on the response. In some examples, the computing device extracts the converted item from the response.

At operation 1024, the computing device pastes the converted item, such as depicted in FIGS. 4 and 8. In some examples, the computing device displays a preview of the converted item before pasting the converted item (e.g., before receiving the user input requesting to paste the item), such as shown in FIG. 7.

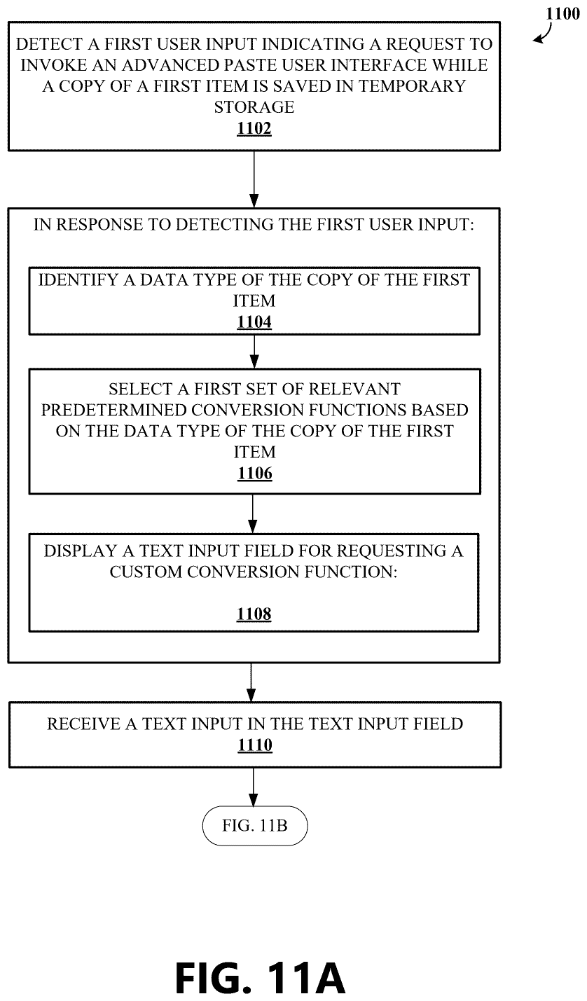

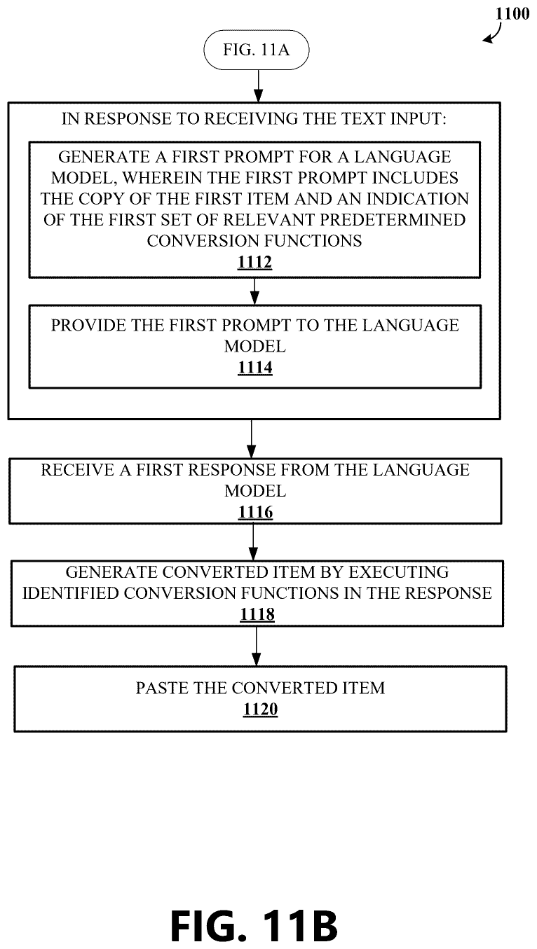

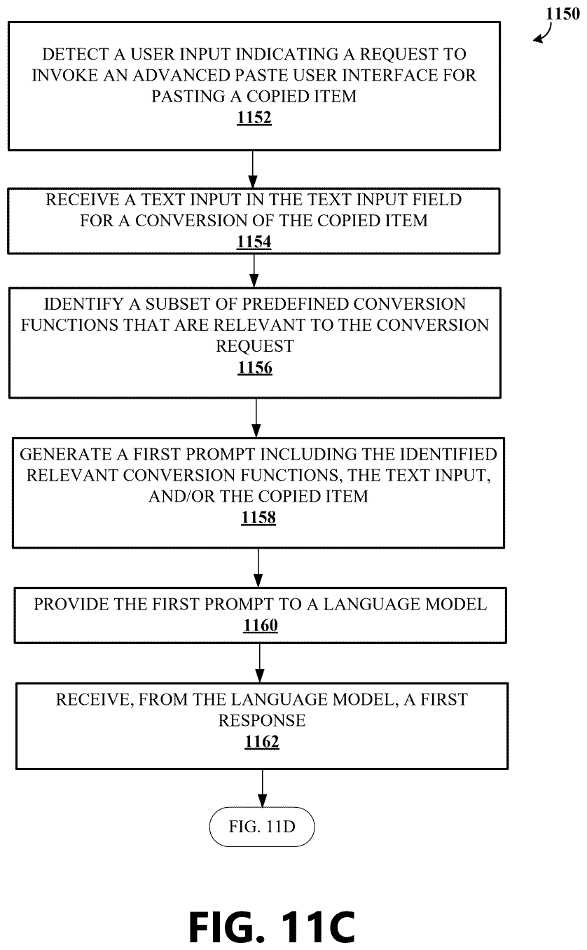

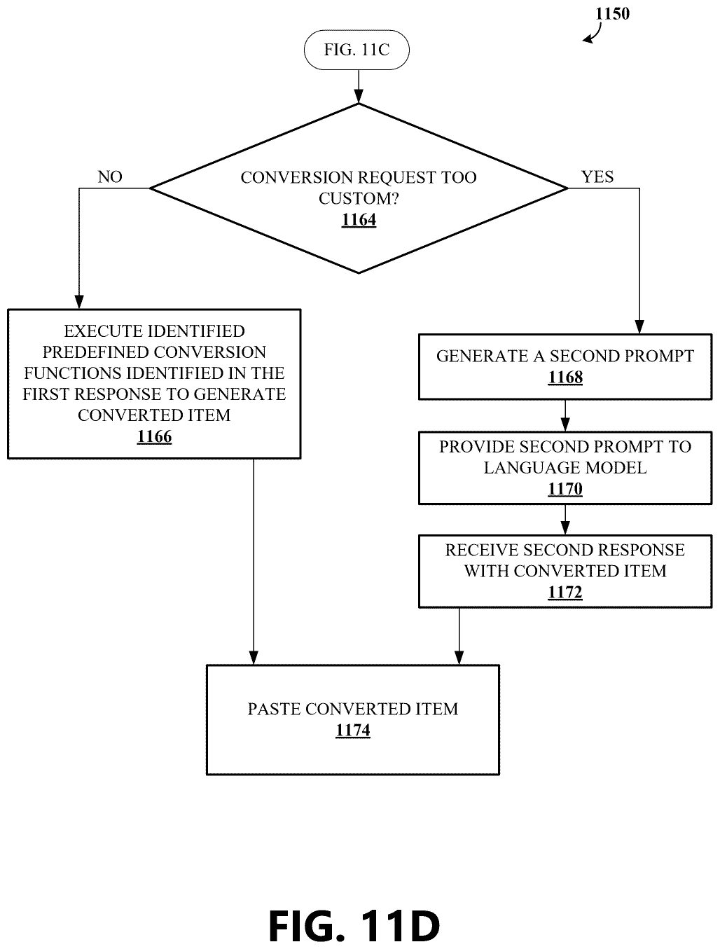

FIGS. 11A-11B depict an example method 1100 for providing advanced copy-and-paste functionality. Method 1100 may be performed by a system (e.g., system 200, 500, 900), such as by a computing device of the system (e.g., computing device 300, 600, and/or 1200).

At operation 1102, the computing device detects a first user input indicating a request to invoke an advanced paste user interface while a copy of a first item is saved in temporary storage (e.g., after the user has selected and copied the first item to temporary storage, such as shown in FIG. 2). In response to detecting the first user input, the computing device performs operations 1104-1108.

At operation 1104, the computing device identifies a data type of the copy of the first item, such as described with reference to operation 1008 of FIG. 10A. At operation 1106, the computing device selects a first set of relevant predefined conversion functions based on the data type of the copy of the first item. In some examples, the computing device selects the first set of relevant predefined conversion functions as described with reference to operation 1010 of FIG. 10A.

At operation 1108, the computing device displays a text input field for requesting a custom conversion function (e.g., text input field 312, 612 in advanced paste UI 308, 608). At operation 1110, the computing device receives a text input in the text input field such as shown in FIG. 6, in which the user enters the natural language text “Convert to Python and highlight syntax like VS” as a custom paste request. In response to receiving the text input, the computing device performs operations 1112-1114.

At operation 1112 the computing device generates a prompt for a language model, where the prompt includes the copy of the first item and an indication of a first set of relevant predefined conversion functions. At operation 1114 the computing device provides the prompt to the language model as described with respect to operation 1018 of FIG. 10B.

At operation 1116, the computing device receives a response from the language model as described with respect to operation 1020 of FIG. 10B. The response includes one or more relevant predefined conversion functions (or an identification thereof) to perform the requested custom conversion of the copied data item. At operation 1118, the computing device generates a converted item by executing the one or more relevant conversion functions identified in the response from the language model. At operation 1120, the computing device pastes the converted item as described with respect to operation 1024 of FIG. 10B.

FIGS. 11C-D depict another example method 1150 for providing advanced copy-and-paste functionality. Method 1150 may be performed by a system (e.g., system 200, 500, 900), such as by a computing device of the system (e.g., computing device 300, 600, and/or 1200).

At operation 1152, the computing device detects a user input indicating a request to invoke an advanced paste user interface to convert and paste a copied item. At operation 1154, a text input is received into the text input field. The text input requests a conversion of the copied item to a different format or other type of conversion. The text input may be in freeform or natural language text.

At operation 1156, a subset of predefined conversion functions that are relevant to the requested conversion of the copied item are identified. The relevant predefined conversion functions are those functions that are likely to be useful in performing the requested conversion. As discussed above, this subset of relevant conversion functions may be performed via an embedding comparison analysis.

At operation 1158, a first prompt is generated that includes the relevant predefined conversion functions that were identified as the subset in operation 1156. The first prompt also includes the text input received in operation 1154 requesting the conversion. In some examples, the first prompt further includes the copied data item, but in some examples, the copied data item is not included. The first prompt further includes instructions that instruct the language model to identify the predefined conversion function(s) that can be used to perform the requested conversion.

At operation 1160, the first prompt is provided to a language model. The language model then processes that first prompt and generates a first response. At operation 1162, the first response is received.

At operation 1164, based on the first response, a decision may be made as to whether the conversion requested is too custom to be handled by the predefined conversion functions. In some examples, this is determined if the first response indicates that no combination of the conversion functions can be used to perform the requested conversion. In other examples, a confidence score for the identified conversion functions in the first response may be below a confidence threshold, which indicates that the requested conversion is too custom. In still other examples, one of the predefined conversion functions may be a “too custom” function. If the “too custom” function is identified in the first response as the relevant conversion function to be used, then the conversion request may be determined to be too custom.

If the conversion request is determined not to be too custom at operation 1164, then the method 1150 flows to operation 1166. At operation 1166, the predefined conversion functions identified in the first response are executed to generate the converted item (e.g., by converting the copied item to the converted item). At operation 1172, the converted item is pasted.

If at operation 1164, the requested conversion is too custom, the method 1150 flows to operation 1168. At operation 1168 a second prompt is generated. The second prompt includes the copied data item, the text input for the conversion request, and instructions for the language model to convert the copied data item according to the text input for the conversion request. At operation 1170, the second prompt is provided to the language model. The language model processes the second prompt to perform the requested conversion and generate a second response with the converted data item. The second response with the converted item is then received in operation 1172. The converted item is extracted from the second response and pasted in operation 1174.

In some examples where a “too custom” function is identified in the first response received in operation 1162, the too custom function may include the operations 1168 and 1170. Thus, executing the too custom function causes operations 1168 and 1170 to be performed.

FIG. 12 is a block diagram illustrating physical components (e.g., hardware) of a computing device 1200 with which examples of the present disclosure may be practiced. The computing device components described below may be suitable for one or more of the components of the systems 100, 200 described above. In a basic configuration, the computing device 1200 includes at least one processing unit 1202 and a system memory 1204. Depending on the configuration and type of computing device 1200, the system memory 1204 may comprise volatile storage (e.g., random access memory), non-volatile storage (e.g., read-only memory), flash memory, or any combination of such memories. The system memory 1204 may include an operating system 1205 and one or more program modules 1206 suitable for running software applications 1250 (e.g., applications 112, applications for providing advanced copy-and-paste functions) and other applications.

The operating system 1205 may be suitable for controlling the operation of the computing device 1200. Furthermore, aspects of the disclosure may be practiced in conjunction with a graphics library, other operating systems, or any other application program and is not limited to any particular application or system. This basic configuration is illustrated in FIG. 12 by those components within a dashed line 1208. The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by a removable storage device 1209 and a non-removable storage device 1210.

As stated above, a number of program modules and data files may be stored in the system memory 1204. While executing on the processing unit 1202 (e.g., a processing system that includes one or more microprocessors), the program modules 1206 may perform processes including one or more of the operations of the methods and processes discussed herein, such the methods of FIGS. 10A-11B. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 1200 on the single integrated circuit (chip). Examples of the present disclosure may also be practiced using other technologies capable of performing logical operations such as, for example, AND, OR, and NOT, including mechanical, optical, fluidic, and quantum technologies.

The computing device 1200 may also have one or more input device(s) 1212 such as a keyboard, a mouse, a pen, a sound input device, a touch input device, a camera, etc. The output device(s) 1214 such as a display, speakers, a printer, etc. may also be included. The aforementioned devices are examples and others may be used. The computing device 1200 may include one or more communication connections 1216 allowing communications with other computing devices 1218. Examples of suitable communication connections 1216 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 1204, the removable storage device 1209, and the non-removable storage device 1210 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. Any such computer readable media may be part of the computing device 1200. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As should be appreciated from the foregoing, the technology relates to systems and computer-implemented methods for providing advanced copy-and-paste functionality. In an aspect, the technology relates to a computer-implemented method for providing advanced paste functions. The method includes detecting a first user input indicating a request to copy an electronic item for pasting; in response to detecting the first user input, saving a copy of the item in temporary storage; detecting a second user input indicating a request to invoke an advanced paste user interface (UI); in response to detecting the second user input: identifying a data type of the copy of the item, selecting a first set of relevant predefined conversion functions based on the data type, and displaying the advanced paste UI with: a first set of selectable affordances corresponding to the first set of relevant predefined conversion functions, and a text input field for requesting a custom conversion function. The method further includes receiving a text input in the text input field; in response to receiving the text input, generating a prompt for a language model, wherein the prompt includes the copy of the item and the text input; providing the prompt to the language model; receiving a response from the language model; obtaining a converted item based on the response; and pasting the converted item.

In an example, the response includes the converted item. In another example, the method further includes selecting a second set of relevant predefined conversion functions based on the text input and the data type of the copy of the item, wherein: the prompt further comprises the second set of relevant predefined conversion functions, the response includes an indication of at least one selected relevant predefined conversion function of the second set of relevant predefined conversion functions, and obtaining the converted item comprises executing the at least one selected predefined conversion function on the copy of the item to generate the converted item. In a further example, selecting the second set of relevant predefined conversion functions includes: obtaining an embedding vector representing the text input; obtaining a set of available relevant predefined conversion functions based on the data type of the copy of the item; obtaining the second set of relevant predefined conversion functions by: comparing embedding vectors representing the second set of available relevant predefined conversion functions with the embedding vector representing the text input, and selecting the second set of relevant predefined conversion functions based on the comparison. In yet another example, the at least one selected relevant predefined conversion function includes an indication of a first selected relevant predefined conversion function and an indication of a second selected relevant predefined conversion function, and the response includes an order of execution for the first selected relevant predefined conversion function and the second selected relevant predefined conversion function, and executing the at least one selected relevant predefined conversion function on the copy of the item comprises executing the first selected relevant predefined conversion function and the second selected relevant predefined conversion function in an order that is based on the order of execution.

In another example, the method further includes after obtaining the converted item: storing the converted item in the temporary storage, and detecting a third user input requesting to paste the converted item, wherein the converted item is pasted based on receiving the third user input. In a further example, the method further includes before detecting the third user input, displaying a preview of the converted item. In yet another example, a data type of the converted item is different from a data type of the item. In still another example, the item comprises first text in a first computer language and the converted item comprises second text in a second computer language. In still yet another example, the method further includes detecting a fourth user input indicating a request to invoke the advanced paste user interface (UI) while a copy of a second item is stored in the temporary storage; in response to detecting the fourth user input: identifying a data type of the copy of the second item, wherein the data type of the copy of the second item is different from the data type of the copy of the item; selecting a third set of relevant predefined conversion functions based on the data type of the copy of the second item, wherein at least one of the relevant predefined conversion functions of the third set of predefined conversion functions is excluded from the first set of relevant predefined conversion functions; displaying the advanced paste UI with: a second set of selectable affordances corresponding to the third set of relevant predefined conversion functions, and the text input field; detecting a fifth user input indicating a selection of a first selectable affordance of second set of selectable affordances, wherein the first selectable affordance corresponds to a first relevant predefined conversion function; in response receiving the fifth user input, performing the first relevant predefined conversion function on the copy of the second item to generate a second converted item; detecting a sixth user input indicating a request to paste the second converted item; and in response to detecting the sixth user input, pasting the second converted item.

In another aspect, the technology relates to a computer-implemented method for providing advanced paste functions. The method includes detecting a first user input indicating a request to invoke an advanced paste user interface while a copy of a first item is saved in temporary storage; in response to detecting the first user input: identifying a data type of the copy of the first item, selecting a first set of relevant predefined conversion functions based on the data type of the copy of the first item, and displaying a text input field for requesting a custom conversion function; receiving a text input in the text input field; in response to receiving the text input: generating a prompt for a language model, wherein the prompt includes the copy of the first item and a list of the first set of relevant predefined conversion functions, and providing the prompt to the language model; receiving a response from the language model; obtaining a converted item based on the response; and pasting the converted item.

In an example, the response includes an indication of at least one relevant predefined conversion function of the first set of relevant predefined conversion functions, and obtaining the converted item comprises executing the at least one relevant predefined conversion function on the copy of the item to generate the converted item. In a further example, the at least one relevant predefined conversion function includes a first relevant predefined conversion function and a second relevant predefined conversion function, and the response includes an order of execution for the first relevant predefined conversion function and the second relevant predefined conversion function, and executing the at least one relevant predefined conversion function on the copy of the item comprises executing the first relevant predefined conversion function and the second relevant predefined conversion function in an order that is based on the order of execution. In yet another example, the method further includes before detecting the first user input, detecting a second user input indicating a request to save the first item for pasting; and in response to detecting the second user input, saving the copy of the first item in the temporary storage.

In another aspect, the technology relates to a system for advanced copy-and-paste, the system includes: a processing system; and memory storing instructions that, when executed by the processing system, cause the system to perform operations. The operations include detecting a first user input indicating a request to copy an electronic item for pasting; in response to detecting the first user input, saving a copy of the item in temporary storage; detecting a second user input indicating a request to invoke an advanced paste user interface (UI); in response to detecting the second user input: identifying a data type of the copy of the item, selecting a first set of relevant predefined conversion functions based on the data type, and displaying the advanced paste UI with: a first set of selectable affordances corresponding to the first set of relevant predefined conversion functions, and a text input field for requesting a custom conversion function; receiving a text input in the text input field; in response to receiving the text input, generating a prompt for a language model, wherein the prompt includes the copy of the item and the text input; providing the prompt to the language model; receiving a response from the language model; obtaining a converted item based on the response; and pasting the converted item.

In an example, the response includes the converted item. In another example, the instructions further cause the system to perform operations including selecting a second set of relevant predefined conversion functions based on the text input and the data type of the copy of the item, wherein: the prompt further comprises the second set of relevant predefined conversion functions, the response includes an indication of at least one selected relevant predefined conversion function of the second set of relevant predefined conversion functions, and obtaining the converted item comprises executing the at least one selected predefined conversion function on the copy of the item to generate the converted item. In a further example, selecting the second set of relevant predefined conversion functions includes: obtaining an embedding vector representing the text input; obtaining a set of available relevant predefined conversion functions based on the data type of the copy of the item; obtaining the second set of relevant predefined conversion functions by: comparing embedding vectors representing the second set of available relevant predefined conversion functions with the embeddings vector representing the text input, and selecting the second set of relevant predefined conversion functions based on the comparison. In yet another example, the at least one selected relevant predefined conversion function includes an indication of a first selected relevant predefined conversion function and an indication of a second selected relevant predefined conversion function, and the response includes an order of execution for the first selected relevant predefined conversion function and the second selected relevant predefined conversion function, and executing the at least one selected relevant predefined conversion function on the copy of the item comprises executing the first selected relevant predefined conversion function and the second selected relevant predefined conversion function in an order that is based on the order of execution. In still another example, the instructions further cause the system to perform operations including after obtaining the converted item: storing the converted item in the temporary storage, and detecting a third user input requesting to paste the converted item, wherein the converted item is pasted based on receiving the third user input.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computer-implemented method for providing advanced paste functions, the method comprising:
detecting a first user input indicating a request to copy an electronic item for pasting;
in response to detecting the first user input, saving a copy of the item in temporary storage;
detecting a second user input indicating a request to invoke an advanced paste user interface (UI);
in response to detecting the second user input:
identifying a data type of the copy of the item,
selecting a first set of relevant predefined conversion functions based on the data type, and
displaying the advanced paste UI with:
a first set of selectable affordances corresponding to the first set of relevant predefined conversion functions, and
a text input field for requesting a custom conversion function;
receiving a text input in the text input field;
in response to receiving the text input, generating a prompt for a language model, wherein the prompt includes the copy of the item and the text input;
providing the prompt to the language model;
receiving a response from the language model;
obtaining a converted item based on the response; and
pasting the converted item.

2. The method of claim 1, wherein the response includes the converted item.

3. The method of claim 1, further comprising:
selecting a second set of relevant predefined conversion functions based on the text input and the data type of the copy of the item, wherein:
the prompt further comprises the second set of relevant predefined conversion functions,
the response includes an indication of at least one selected relevant predefined conversion function of the second set of relevant predefined conversion functions, and
obtaining the converted item comprises executing the at least one selected predefined conversion function on the copy of the item to generate the converted item.

4. The method of claim 3, wherein selecting the second set of relevant predefined conversion functions comprises:
obtaining an embedding vector representing the text input;
obtaining a set of available relevant predefined conversion functions based on the data type of the copy of the item;
obtaining the second set of relevant predefined conversion functions by:
comparing embedding vectors representing the second set of available relevant predefined conversion functions with the embedding vector representing the text input, and
selecting the second set of relevant predefined conversion functions based on the comparison.

5. The method of claim 3, wherein:
the at least one selected relevant predefined conversion function includes an indication of a first selected relevant predefined conversion function and an indication of a second selected relevant predefined conversion function, and
the response includes an order of execution for the first selected relevant predefined conversion function and the second selected relevant predefined conversion function, and
executing the at least one selected relevant predefined conversion function on the copy of the item comprises executing the first selected relevant predefined conversion function and the second selected relevant predefined conversion function in an order that is based on the order of execution.

6. The method of claim 1, further comprising:
after obtaining the converted item:
storing the converted item in the temporary storage, and
detecting a third user input requesting to paste the converted item, wherein the converted item is pasted based on receiving the third user input.

7. The method of claim 6, further comprising:
before detecting the third user input, displaying a preview of the converted item.

8. The method of claim 1, wherein a data type of the converted item is different from a data type of the item.

9. The method of claim 1, wherein the item comprises first text in a first computer language and the converted item comprises second text in a second computer language.

10. The method of claim 1, further comprising:
detecting a fourth user input indicating a request to invoke the advanced paste user interface (UI) while a copy of a second item is stored in the temporary storage;
in response to detecting the fourth user input:
identifying a data type of the copy of the second item, wherein the data type of the copy of the second item is different from the data type of the copy of the item;
selecting a third set of relevant predefined conversion functions based on the data type of the copy of the second item, wherein at least one of the relevant predefined conversion functions of the third set of predefined conversion functions is excluded from the first set of relevant predefined conversion functions;
displaying the advanced paste UI with:
a second set of selectable affordances corresponding to the third set of relevant predefined conversion functions, and
the text input field;
detecting a fifth user input indicating a selection of a first selectable affordance of second set of selectable affordances, wherein the first selectable affordance corresponds to a first relevant predefined conversion function;
in response receiving the fifth user input, performing the first relevant predefined conversion function on the copy of the second item to generate a second converted item;
detecting a sixth user input indicating a request to paste the second converted item; and
in response to detecting the sixth user input, pasting the second converted item.

11. A computer-implemented method for providing advanced paste functions, the method comprising:
detecting a first user input indicating a request to invoke an advanced paste user interface while a copy of a first item is saved in temporary storage;
in response to detecting the first user input:
identifying a data type of the copy of the first item,
selecting a first set of relevant predefined conversion functions based on the data type of the copy of the first item, and
displaying a text input field for requesting a custom conversion function;
receiving a text input in the text input field;
in response to receiving the text input:
generating a prompt for a language model, wherein the prompt includes the copy of the first item and a list of the first set of relevant predefined conversion functions, and
providing the prompt to the language model;
receiving a response from the language model;
obtaining a converted item based on the response; and
pasting the converted item.

12. The method of claim 11, wherein the response includes an indication of at least one relevant predefined conversion function of the first set of relevant predefined conversion functions, and obtaining the converted item comprises executing the at least one relevant predefined conversion function on the copy of the item to generate the converted item.

13. The method of claim 12, wherein:
the at least one relevant predefined conversion function includes a first relevant predefined conversion function and a second relevant predefined conversion function, and
the response includes an order of execution for the first relevant predefined conversion function and the second relevant predefined conversion function, and
executing the at least one relevant predefined conversion function on the copy of the item comprises executing the first relevant predefined conversion function and the second relevant predefined conversion function in an order that is based on the order of execution.

14. The method of claim 11, further comprising:
before detecting the first user input, detecting a second user input indicating a request to save the first item for pasting; and
in response to detecting the second user input, saving the copy of the first item in the temporary storage.

15. A system for advanced copy-and-paste, the system comprising:
a processing system; and
memory storing instructions that, when executed by the processing system, cause the system to perform operations comprising:
detecting a first user input indicating a request to copy an electronic item for pasting;
in response to detecting the first user input, saving a copy of the item in temporary storage;
detecting a second user input indicating a request to invoke an advanced paste user interface (UI);
in response to detecting the second user input:
identifying a data type of the copy of the item,
selecting a first set of relevant predefined conversion functions based on the data type, and
displaying the advanced paste UI with:
a first set of selectable affordances corresponding to the first set of relevant predefined conversion functions, and
a text input field for requesting a custom conversion function;
receiving a text input in the text input field;
in response to receiving the text input, generating a prompt for a language model, wherein the prompt includes the copy of the item and the text input;
providing the prompt to the language model;
receiving a response from the language model;
obtaining a converted item based on the response; and
pasting the converted item.

16. The system of claim 15, wherein the response includes the converted item.

17. The system of claim 15, wherein the instructions further cause the system to perform operations comprising:
selecting a second set of relevant predefined conversion functions based on the text input and the data type of the copy of the item, wherein:
the prompt further comprises the second set of relevant predefined conversion functions,
the response includes an indication of at least one selected relevant predefined conversion function of the second set of relevant predefined conversion functions, and
obtaining the converted item comprises executing the at least one selected predefined conversion function on the copy of the item to generate the converted item.

18. The system of claim 17, wherein selecting the second set of relevant predefined conversion functions comprises:
obtaining an embedding vector representing the text input;
obtaining a set of available relevant predefined conversion functions based on the data type of the copy of the item;
obtaining the second set of relevant predefined conversion functions by:
comparing embedding vectors representing the second set of available relevant predefined conversion functions with the embeddings vector representing the text input, and
selecting the second set of relevant predefined conversion functions based on the comparison.

19. The system of claim 17, wherein:
the at least one selected relevant predefined conversion function includes an indication of a first selected relevant predefined conversion function and an indication of a second selected relevant predefined conversion function, and
the response includes an order of execution for the first selected relevant predefined conversion function and the second selected relevant predefined conversion function, and
executing the at least one selected relevant predefined conversion function on the copy of the item comprises executing the first selected relevant predefined conversion function and the second selected relevant predefined conversion function in an order that is based on the order of execution.

20. The system of claim 15, wherein the instructions further cause the system to perform operations comprising:
after obtaining the converted item:
storing the converted item in the temporary storage, and
detecting a third user input requesting to paste the converted item, wherein the converted item is pasted based on receiving the third user input.
